(19) United States
(12) Patent Application Publication
(10) Pub. No.: US 2008/0037780 A1
(43) Pub. Date: Feb. 14, 2008

(54) Content Protection System And Method

(76) Inventor: Leonard Layton, Marrickville (AU)

Correspondence Address: ST. ONGE STEWARD JOHNSTON & REENS, LLC, 986 BEDFORD STREET, STAMFORD, CT, 06905-5619, US

(21) Appl. No.: 11/779,042

(22) Filed: Jul. 17, 2007

Related U.S. Application Data
(63) Continuation of application No. PCT/AU06/00052, filed on Jan. 17, 2006.

(30) Foreign Application Priority Data
Jan. 17, 2005 (AU) 2005900198

(51) Int. Cl. H04N 7/167

(52) U.S. Cl. 380/201

(57) ABSTRACT

A content protection system including: a user interface for providing data modification parameters for protected and unprotected digital content, the protected digital content being encrypted; a software driver application for receiving the data modification parameters, processing the unprotected content in accordance with the modification parameters, and distributing the modification parameters to a protected content application; a protected content application having a protected data area wherein the protected data is decrypted into computer readable data, processed according to the data modification parameters, and re-encrypted for delivery to a rendering device; a rendering device including a rendering interface for decrypting the modified protected data, mixing it with the unprotected data to produce mixed data and outputting the mixed data.

### CROSS-REFERENCE TO RELATED APPLICATIONS

The present application is a continuation of pending International patent application PCT/AU2006/000052 filed on Jan. 17, 2006 which designates the United States and claims priority from Australian patent application 2005900198 filed on Jan. 17, 2005, the content of which is incorporated herein by reference.

### FIELD OF THE INVENTION

The present invention relates to a content protection system and method, and particularly to a content protection system and method for protecting digital content.

The invention has been developed primarily for use as content protection system for digital media applications and will be described hereinafter with reference to this application. However it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

The rising prevalence of unauthorised duplication and distribution of digital media has caused great concern to the legal owners of copyrighted material in recent years, prompting a push towards more stringent methods of copyright protection. This situation is mostly concerned with the unlawful piracy of movies and music files which are continuously being offered for download via the internet. Traditional copyright protection methods such as infringement lawsuits are suitable only in specific cases and are not practical on a mass scale.

In attempts to combat this piracy, digital distribution media (such as digital versatile discs (DVDs) and compact discs (CDs)) containing the copyrighted material have been issued with copyright protection schemes to prevent copying of the data. These schemes usually include copy protection methods were the data contained on the distribution media is encrypted and a decryption key is needed to be able to access the content. The copy protection methods however, have been largely ineffective, mainly due to the persistence of computers hackers in cracking the encryption schemes, but also because the encrypted content must necessarily be decrypted into standard pulse code modulation (PCM) form before being delivered to the hardware interface. In consumer products such as DVD players and stereo systems which have fixed hardware and firmware configurations and do not allow for user-installed upgrades and modifications, the integrity of the unencrypted data stream can be effectively managed. In consumer computer systems however, this situation is completely different. The ability of a user to frequently install and modify their own personal software and hardware presents a difficult task to the content providers of maintaining the integrity of the entire data stream once it has been decrypted into PCM and sent to the hardware interface. Current content protection systems (Digital Rights Management (DRM) systems) generally focus on the protecting the content files themselves rather than the playback chain. Thus, it becomes increasingly possible for an external agent, typically a software application or a hardware device driver, to exploit the vulnerabilities in playback systems and interfere with the unencrypted PCM data stream, thereby enabling the user to make unlicensed copies of the digital content which can be freely distributed if desired. Implementing techniques to counter this type of attack has been difficult since personal computer systems also have unprotected content which must be simultaneously supported and users are particularly resistant to solutions that either reduce convenience or increase complexity in order to protect copyrighted content.

### SUMMARY OF THE INVENTION

It is an object of the invention in its preferred form to provide an improved digital content protection system.

In accordance with a first aspect of the present invention, there is provided a content protection system including: a user interface for providing data modification parameters for protected and unprotected digital content, the protected digital content being encrypted; a software driver application for receiving the data modification parameters, processing the unprotected content in accordance with the modification parameters, and distributing the modification parameters to a protected content application; a protected content application having a protected data area wherein the protected data is decrypted into computer readable data, processed according to the data modification parameters, and re-encrypted for delivery to a rendering device; a rendering device including a rendering interface for decrypting the modified protected data, mixing it with the unprotected data to produce mixed data and outputting the mixed data.

Preferably, the software driver application receives the reencrypted data from the protected content application and forwards it unaltered to the rendering device and the software driver application does not can include software protection schemes. Preferably, the protected content application authenticates the rendering device by mutual exchange of encryption keys.

The protected content application encrypts the modified protected content using encryption keys obtained from the rendering device interface.

In accordance with a further aspect of the present invention, there is provided a content protection system including: a parameter input interface for inputting manipulation parameters; first data manipulation unit for manipulating a first data stream in accordance with the manipulation parameters; second data manipulation unit having a tamper resistant area for decrypting and manipulating an encrypted data stream in accordance with the manipulation parameters to form a manipulated secure data stream, before reencrypting the manipulated secure data stream to form a second encrypted data stream; a rendering unit receiving the first and second data stream and decrypting the second encrypted data stream in a second tamper resistant area and mixing the first and second data stream for output.

Preferably, the second data manipulation unit reencypts the manipulated secure data stream utilising keys obtained from the rendering unit using an authentication key exchange protocol. At least one of the data streams can comprise audio information.

### BRIEF DESCRIPTION OF THE DRAWINGS

A preferred embodiment of the invention will now be described, by way of example only, with reference to the accompanying drawings in which:

FIG. 1 is a schematic overview of a content protection system;

FIG. 2 is a schematic diagram of a protected media application according to the content protection system;

FIG. 3 is a schematic diagram of a software driver application of the content protection system; and

FIG. 4 is a schematic diagram of a hardware device interface and hardware output device of the content protection system.

### DETAILED DESCRIPTION OF THE INVENTION

Current content protections systems for encrypted media streams such as for example Apple “FairPlay”, Microsoft DRM (codenamed Janus) or the CPPM (Content Protection for Pre-recorded Media, used for DVD-Audio formats) standard all focus primarily on the protection of online content distribution of media files (for example music or video) via the Internet. They do not encompass the whole playback chain from the data storage medium (eg compact disc or DVD) to a hardware interface device eg speakers or a monitor. Before being sent to a digital-to-analogue (DAC) converter and then on to the standard hardware device common on personal computer systems, the encrypted digital data must be converted to unencrypted pulse code modulation (PCM) format at which point it is vulnerable to copying.

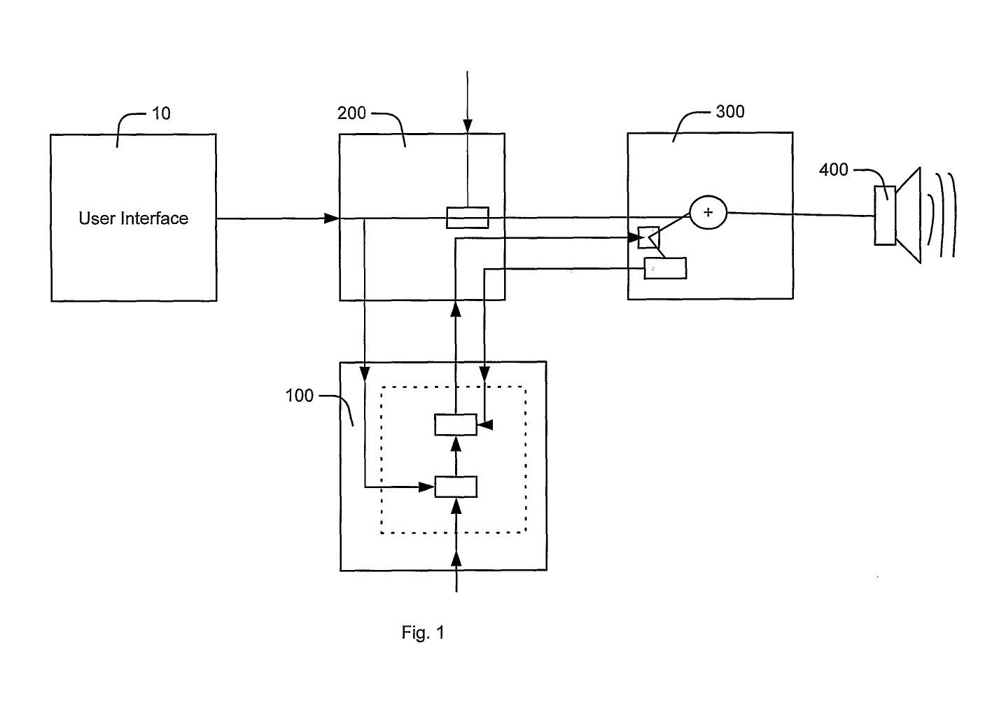

To overcome this limitation, the current content protection system shown in FIG. 1 provides a user interface 10, a media player application 100, a software driver application 200, a hardware device interface 300 and a hardware output device 400.

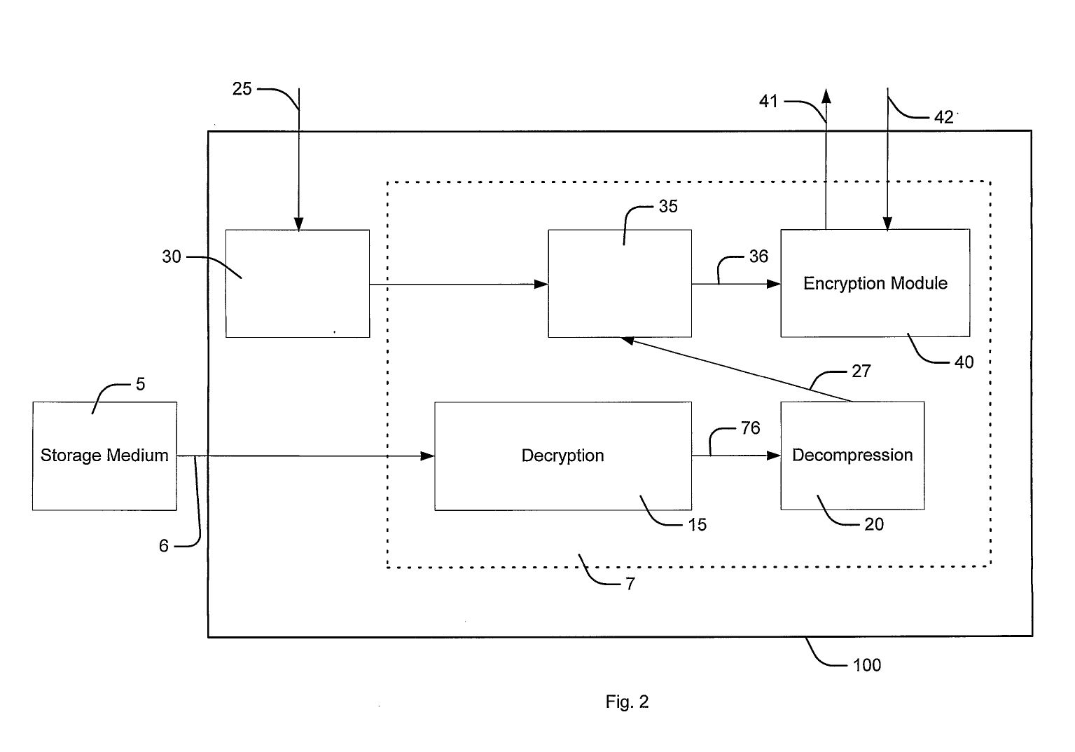

The media player application 100 is shown in detail in FIG. 2. Encrypted media format (EMF) data stored on a storage medium 5 is input 6 into the media player application and directly into the protected software area 7. The protected software area is a tamper proof area which can be implemented utilising code obfuscation tool available from Cloakware Inc. of, Vienna, Va., USA (www.clokware.com). The media data stream is decrypted 15 within the protected software area using an appropriate Decryption Key in the usual fashion. This results in an unencrypted, compressed media stream in a compressed media format (CMF). The compressed data is then decompressed 20 into pulse code modulation (PCM) format. PCM is the standard for uncompressed digital audio and is the format most susceptible to copying. By ensuring that the PCM data stream remains at all times in the protected software area of the media application, the integrity of the data is maintained. Control processing parameters 25 such as, for example, volume control, equalization, bass management or delays are input to the media player application 100 via a control application program interface (API) 30. These control parameters are fed into the protected software area 10 where the unencrypted PCM data stream is processed 35 in accordance with these parameters. The modified PCM data stream 36 is then encrypted in an encryption module 40 into a transfer encryption format (TEF) media stream 41 to be sent from the media player application 100 to a hardware device. The encryption key 42 used by the encryption module 40 to secure the protected media content is received from the hardware device interface by a protocol known as authentication and key exchange (AKE) protocol.

The AKE protocol allows for transfer of authentication keys between a hardware device (a receiver) and an encrypted media transmitter. The protocol couples a single transmitter to a single receiver so that other devices cannot eavesdrop without compromising the encrypted keys, which are continually checked and authenticated to verify the link integrity. The encryption module of the media player as the transmitter simply utilises the encryption keys of the authentication process to protect the media stream until it can be decrypted in the hardware device.

To allow the processing of both encrypted data streams and regular unencrypted data such as audio to be processed together requires the use of an audio device driver application 200 capable of handling two simultaneous paths for media data streams: a protected path and an unprotected path. The device driver is also required to be able to deliver audio processing control instructions to both media paths. This function is necessary since it allows for a single user interface (UI) application 10 to be able to control the processing parameters for both the protected and unprotected data streams without added complexity to the user who alternatively would need two UI applications—one for each media type.

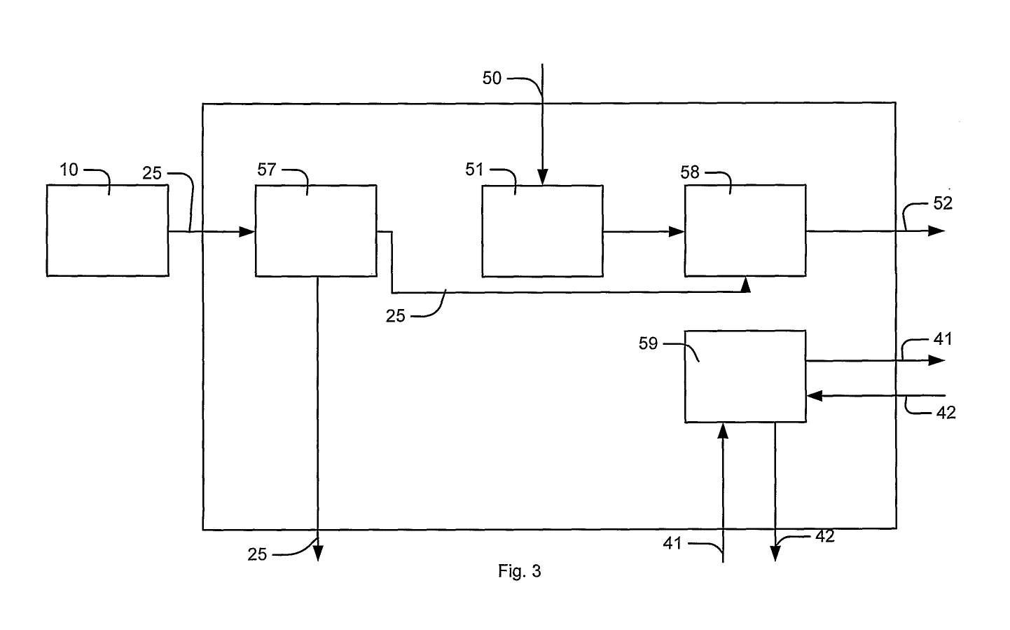

The device driver 200 of the current content protection method is shown in more detail in FIG. 3. Standard unprotected media content 50 in PCM format is received by the device driver in a driver API 51 Control processing parameters 25 from a UI control application are also received in the device driver 200 by a control API 57. The control parameters are then sent simultaneously to a processing module 58 within the device driver 200 and to the control API (30 of FIG. 2) within the media application 100 shown in FIG. 1. The processing module 58 takes the control parameters from the control API 57, applies them to the unencrypted PCM media stream 50, and then forwards the processed media stream 52 to the hardware device. The unencrypted media stream remains in PCM format at all times through the device driver. The device driver 200 also includes an encrypted media transfer module 59. The media transfer module accepts a TEF media stream 41 from the media application 100, and forwards the stream 41 unchanged to the hardware device. It is important to note that the media transfer module does not decrypt the TEF media stream. Therefore, the device driver does not see PCM data of the protected media stream, and hence is not an avenue of attack by hackers wishing to copy the protected content.

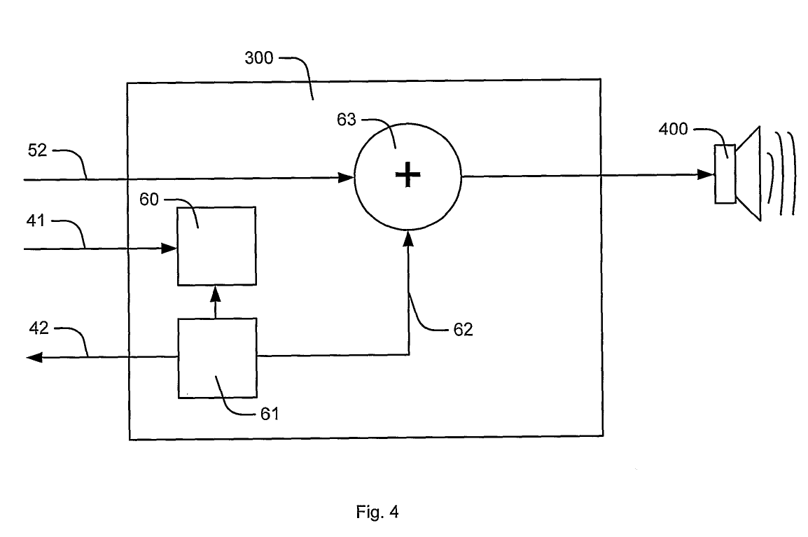

FIG. 4 shows the hardware device 400 and the hardware interface circuitry 300 required for the processing of the two simultaneous media streams 52 and 41, respectively consisting of protected and unprotected content. The encrypted TEF media stream 41 is received by the hardware interface circuitry and decrypted using the TEF keys 42 from the AKE module 61 of the hardware device into a PCM format media stream 62. This is then mixed with the non-protected media stream 52 in a simple hardware mixer 63 and output on the hardware device 400.

The above example shows a method of providing a content protection system that can be utilised for protected content data streams. The benefit of this system is that the software device drivers never see the data stream in an unencrypted format, thus do not need included software protection technology. The only time the protected content is vulnerable is when it is in PCM format. This only occurs within the protected software area of the media application, which has software protection schemes in place to prevent hacking, and in the hardware device itself, which cannot be hacked without compromising the hardware itself or the TEF and authentication keys contained in it.

Modified embodiments are possible. For example, with the advances in wireless technology, it will be evident that the hardware device can be at one end of a wireless connection.

It will be appreciated that the illustrated content protection system provides a secure means of protecting encrypted digital content. The content protection system is primarily for use in digital media applications such as audio and video distribution, however embodiments of the present invention can be envisioned to enable protection of all encrypted digital content which must necessarily be interfaced with a hardware device. Therefore, it is not intended that the invention be restricted solely to media applications. On the contrary, it is intended for the subject matter of the current invention to include all alternatives, modifications and equivalents as can be included within the spirit and full scope of the following claims.

1. A content protection system including:
a user interface for providing data modification parameters for protected and unprotected digital content, said protected digital content being encrypted;
a software driver application for receiving said data modification parameters, processing said unprotected content in accordance with said modification parameters, and distributing said modification parameters to a protected content application;
a protected content application having a protected data area wherein said protected data is decrypted into computer readable data, processed according to said data modification parameters, and re-encrypted for delivery to a rendering device;
a rendering device including a rendering interface for decrypting said modified protected data, mixing it with said unprotected data to produce mixed data and outputting said mixed data.

2. A content protection system as claimed in claim 1 wherein said software driver application receives said re-encrypted data from said protected content application and forwards it unaltered to said rendering device.

3. A content protection system as claimed in claim 2 wherein said software driver application does not include software protection schemes.

4. A content protection system as claimed in claim 1 wherein said protected content application authenticates said rendering device by mutual exchange of encryption keys.

5. A content protection system as claimed in claim 4 wherein said protected content application encrypts said modified protected content using encryption keys obtained from said rendering device interface.

6. A content protection system including:
a parameter input interface for inputting manipulation parameters;
first data manipulation unit for manipulating a first data stream in accordance with said manipulation parameters;
second data manipulation unit having a tamper resistant area for decrypting and manipulating an encrypted data stream in accordance with said manipulation parameters to form a manipulated secure data stream, before reencrypting the manipulated secure data stream to form a second encrypted data stream;
a rendering unit receiving said first and second data stream and decrypting the second encrypted data stream in a second tamper resistant area and mixing said first and second data stream for output.

7. A system as claimed in claim 6 wherein said second data manipulation unit reencypts the manipulated secure data stream utilising keys obtained from the rendering unit using an authentication key exchange protocol.

8. A system as claimed in claim 1 wherein at least one of said data streams comprise audio information.
